(19) United States
(12) Patent Application Publication
(10) Pub. No.: US 2022/0255469 A1
(43) Pub. Date: Aug. 11, 2022

(54) PIEZOELECTRIC MOTOR, CONTROL METHOD FOR PIEZOELECTRIC MOTOR, AND ROBOT

(71) Applicant: SEIKO EPSON CORPORATION, Tokyo (JP)

(72) Inventors: Ryoichi TANAKA, SHIOJIRI-SHI (JP); Tomoaki TAKAHASHI, MATSUMOTO-SHI (JP); Yutaka ARAKAWA, SUWA-GUN HARA-MURA (JP)

(21) Appl. No.: 17/666,592

(22) Filed: Feb. 8, 2022

(30) Foreign Application Priority Data
Feb. 10, 2021 (JP) 2021-019638

(51) Int. Cl. H02N 2/12; H02N 2/10; F16H 25/24; B25J 9/12

(52) U.S. Cl. CPC H02N 2/123; H02N 2/103; F16H 2025/2037; B25J 9/12; F16H 25/24

(57) ABSTRACT

A piezoelectric motor includes a driven body configured to rotate around a rotation axis, a first piezoelectric vibrator configured to transmit a driving force to the driven body, a moving mechanism configured to move the first piezoelectric vibrator in directions approaching and separating from the rotation axis, and a second piezoelectric vibrator configured to transmit a driving force to the moving mechanism. The moving mechanism includes a screw shaft disposed along the directions and configured to rotate around an axis with the driving force of the second piezoelectric vibrator and a holding section configured to screw with the screw shaft and hold the first piezoelectric vibrator.

The present application is based on, and claims priority from JP Application Serial Number 2021-019638, filed Feb. 10, 2021, the disclosure of which is hereby incorporated by reference herein in its entirety.

### BACKGROUND

### 1. Technical Field

The present disclosure relates to a piezoelectric motor, a control method for the piezoelectric motor, and a robot.

### 2. Related Art

For example, JP-A-2018-068112 (Patent Literature 1) discloses a vibration type actuator including three vibrator sections disposed at equal intervals on the same circumference and a ring-shaped driven body rotated by driving of the three vibrator sections.

However, in the vibration type actuator of Patent Literature 1, the three vibrator sections are located on the same circumference. Accordingly, if the diameter of the driven body is large, the vibration type actuator is suited for high torque/low speed. Conversely, if the diameter of the driven body is small, the vibration type actuator is suited for low torque/high speed. Therefore, it is difficult to drive the driven body with excellent energy efficiency over an entire wide speed region.

### SUMMARY

A piezoelectric motor according to an aspect of the present disclosure includes: a driven body configured to rotate around a rotation axis; a first piezoelectric vibrator configured to transmit a driving force to the driven body; a moving mechanism configured to move the first piezoelectric vibrator in directions approaching and separating from the rotation axis; and a second piezoelectric vibrator configured to transmit a driving force to the moving mechanism.

A control method for a piezoelectric motor according to an aspect of the present disclosure is a control method for a piezoelectric motor including: a driven body configured to rotate around a rotation axis; a first piezoelectric vibrator configured to transmit a driving force to the driven body; a moving mechanism configured to move the first piezoelectric vibrator in directions approaching and separating from the rotation axis; and a second piezoelectric vibrator configured to transmit a driving force to the moving mechanism, the control method including, when accelerating the driven body, according to an increase in rotating speed of the driven body, moving the first piezoelectric vibrator in the direction approaching the rotation axis.

A robot according to an aspect of the present disclosure includes: a first member and a second member coupled to each other; and the piezoelectric motor described above configured to displace the second member with respect to the first member.

### BRIEF DESCRIPTION OF THE DRAWINGS

FIG. 1 is a sectional view showing a piezoelectric motor according to a first embodiment of the present disclosure.

FIG. 2 is a plan view of a base included in the piezoelectric motor shown in FIG. 1 viewed from the lower side.

FIG. 3 is a plan view showing a first piezoelectric vibrator and a second piezoelectric vibrator.

FIG. 4 is a diagram showing driving signals applied to the piezoelectric vibrators.

FIG. 5 is a plan view showing driving states of the first piezoelectric vibrator and the second piezoelectric vibrator.

FIG. 6 is a plan view showing an urging member.

FIG. 7 is a graph showing a relation between rotating speed and torque.

FIG. 8 is a plan view showing a moving mechanism of a piezoelectric motor according to a second embodiment of the present disclosure.

FIG. 9 is a perspective view showing a slider included in the moving mechanism.

FIG. 10 is a perspective view showing a robot according to a third embodiment of the present disclosure.

FIG. 11 is a sectional view showing a joint portion of a first arm and a second arm.

### DESCRIPTION OF EXEMPLARY EMBODIMENTS

A piezoelectric motor, a control method for the piezoelectric motor, and a robot according to the present disclosure are explained in detail below with reference to preferred embodiments shown in the accompanying drawings.

### First Embodiment

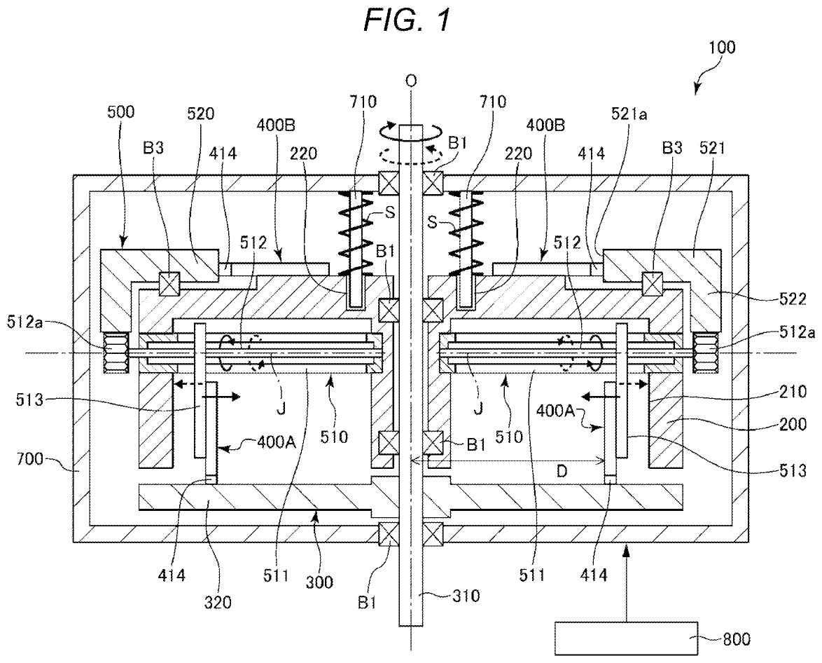

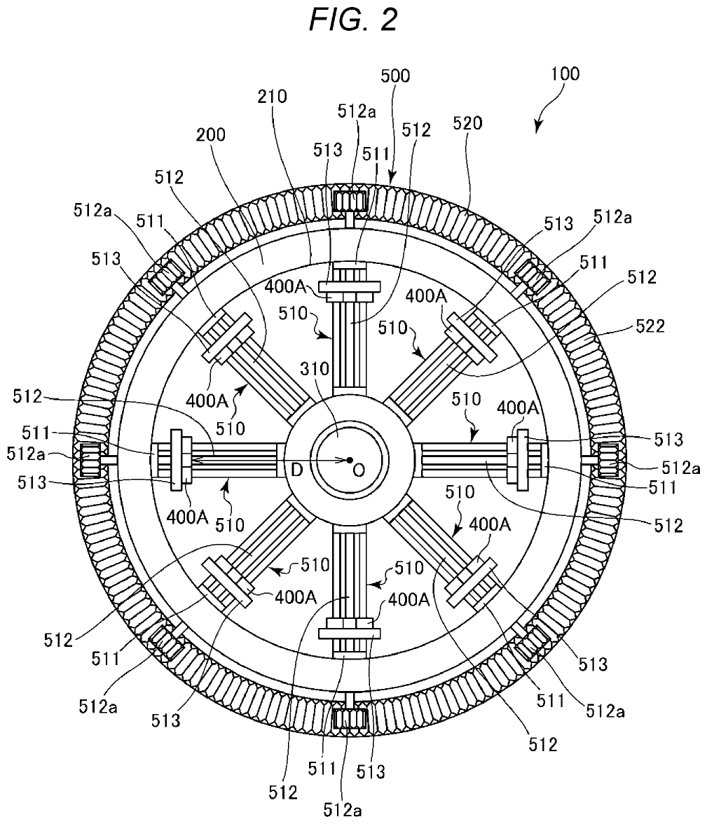

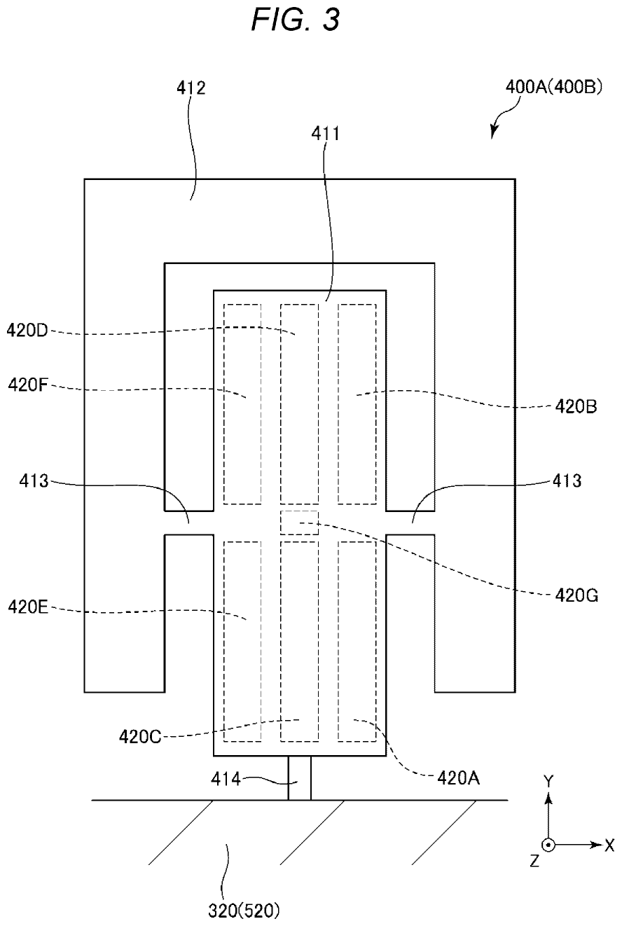

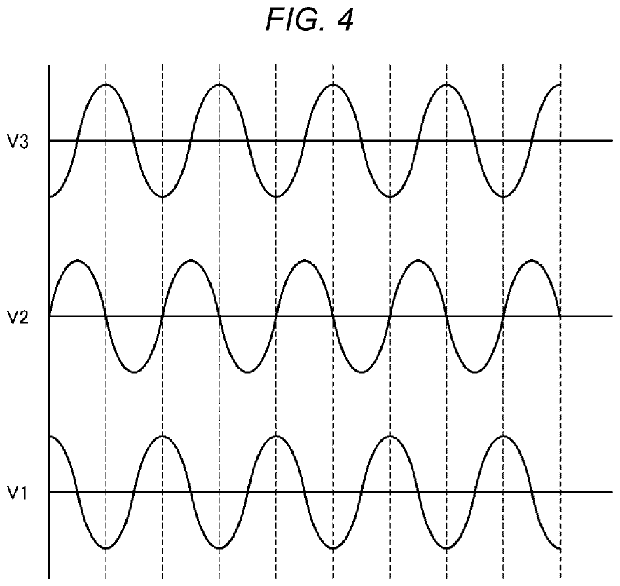

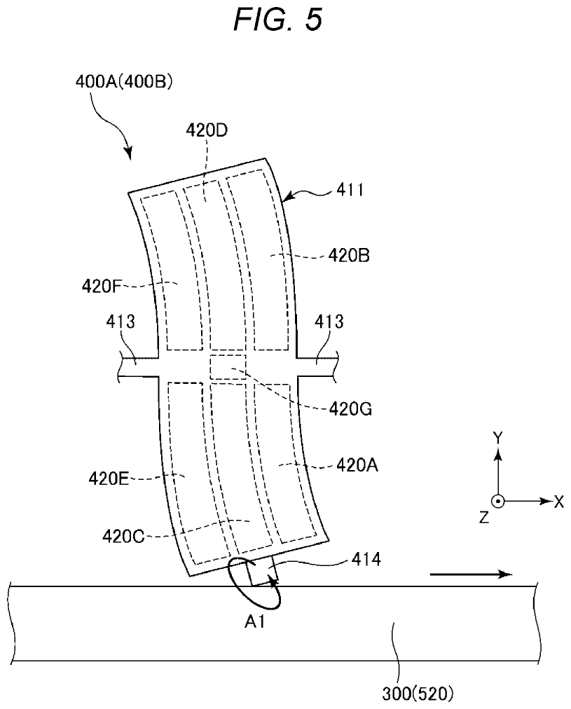

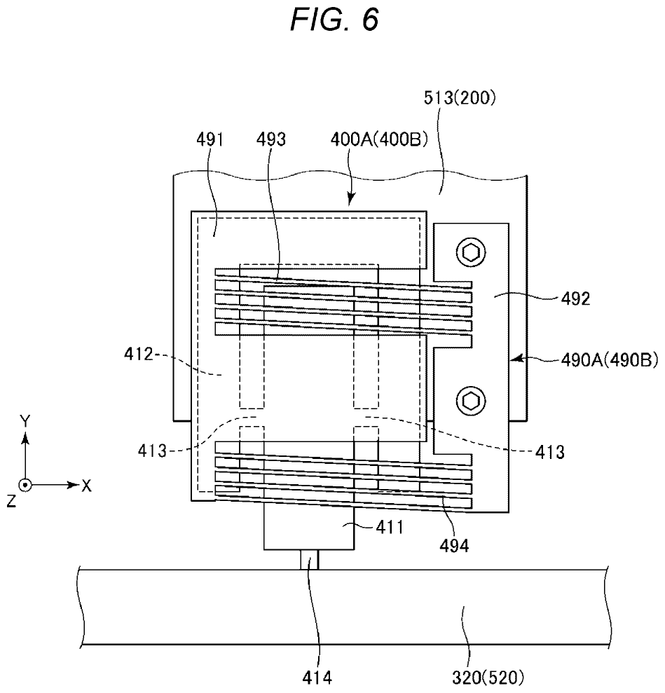

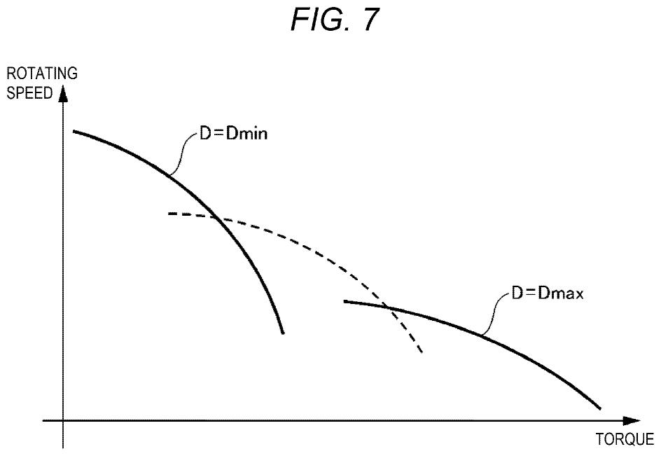

FIG. 1 is a sectional view showing a piezoelectric motor according to a first embodiment of the present disclosure. FIG. 2 is a plan view of a base included in the piezoelectric motor shown in FIG. 1 viewed from the lower side. FIG. 3 is a plan view showing a first piezoelectric vibrator and a second piezoelectric vibrator. FIG. 4 is a diagram showing driving signals applied to the piezoelectric vibrators. FIG. 5 is a plan view showing driving states of the first piezoelectric vibrator and the second piezoelectric vibrator. FIG. 6 is a plan view showing an urging member. FIG. 7 is a graph showing a relation between rotating speed and torque.

In each of FIGS. 3, 5, and 6, three axes of an X axis, a Y axis, and a Z axis orthogonal to one another are shown as coordinate axes specific to a piezoelectric vibrator. In the following explanation, a direction along the X axis is referred to as X-axis direction as well, a direction along the Y axis is referred to as Y-axis direction as well, and a direction along the Z axis is referred to as Z-axis direction as well. An arrow side of the axes is referred to as “plus side” as well and the opposite side of the arrow side is referred to as “minus side” as well.

A piezoelectric motor 100 shown in FIG. 1 includes a base 200, a rotor 300 functioning as a driven body capable of rotating around a rotation axis O with respect to the base 200, first piezoelectric vibrators 400A that rotate the rotor 300 around the rotation axis O, a moving mechanism 500 that moves the first piezoelectric vibrators 400A in the radial direction of the rotor 300, second piezoelectric vibrators 400B that transmit driving forces to the moving mechanism 500, a not-shown encoder that detects a rotation amount of the rotor 300, a case 700 that houses these components, and a control device 800 that controls driving of the first and second piezoelectric vibrators 400A and 400B.

In the piezoelectric motor 100, driving forces of the first piezoelectric vibrators 400A are transmitted to the rotor 300, whereby the rotor 300 rotates around the rotation axis O. The driving forces of the second piezoelectric vibrators 400B are transmitted to the moving mechanism 500, whereby the first piezoelectric vibrators 400A move in the radial direction of the rotor 300. The positions of the first piezoelectric vibrators 400A are changed according to the rotating speed and the magnitude of an output load of the rotor 300. With such a configuration, for example, compared with when the positions of the first piezoelectric vibrators 400A are fixed as in the related art, it is possible to secure a wider rotating speed range of the rotor 300. It is possible to exert excellent driving efficiency by changing the positions of the first piezoelectric vibrators 400A according to necessary rotating speed and necessary torque.

The rotor 300 includes an output shaft 310 extending along the rotation axis O and a disc-like rotor main body 320 fixed to the output shaft 310. The rotor 300 is supported by the base 200 and the case 700 via a bearing B1 and is capable of rotating around the rotation axis O with respect to the base 200 and the case 700. Both ends of the output shaft 310 project from the case 700 and are coupled to other members in the portions of the both ends.

The base 200 is disposed on the upper side of the rotor 300. The base 200 includes a recess 220 opened on the upper surface of the base 200. A bar section 710 extending from the case 700 is inserted into the recess 220. Consequently, rotation of the base 200 around the rotation axis O with respect to the case 700 is restricted. The base 200 is urged to the rotor 300 side by a compression spring S disposed in the bar section 710. The base 200 includes an annular recess 210 opened on the lower surface of the base 200. The recess 210 is disposed concentrically with the output shaft 310 to surround the output shaft 310. The first piezoelectric vibrators 400A and a part of the moving mechanism 500 are disposed on the inner side of the recess 210. That is, the recess 210 functions as a housing section that houses the first piezoelectric vibrators 400A and the moving mechanism 500.

The moving mechanism 500 includes a plurality of ball screws 510 disposed around the rotation axis O and a gear 520 that collectively drives all the ball screws 510. The ball screws 510 include screw bases 511 fixed to the base 200, screw shafts 512 rotatably supported by the screw bases 511, and sliders 513 that move in the axial direction of the screw shafts 512 according to rotation of the screw shafts 512. The sliders 513 hold the first piezoelectric vibrators 400A. The screw shafts 512 include head sections 512a projecting to the outer circumference side of the base 200. The head sections 512a include teeth formed on the outer circumferential surfaces of the head sections 512a and are screwed with the gear 520 via the teeth.

The gear 520 are disposed on the upper side of the base 200. The gear 520 is supported by the base 200 via a bearing B3 and is capable of rotating around the rotation axis O with respect to the base 200. The gear 520 includes an annular main body 521 slightly larger than the base 200 and an annular flange 522 projecting to the lower side from the outer edge portion of the main body 521 and disposed to surround the base 200. The flange 522 includes teeth formed on the lower surface of the flange 522 and is screwed with the head sections 512a of the screw shafts 512 via the teeth. The second piezoelectric vibrators 400B are pressed against an inner circumferential surface 521a of the main body 521.

As indicated by solid line arrows in FIG. 1, when the gear 520 forwardly rotates around the rotation axis O with the driving forces of the second piezoelectric vibrators 400B, all the screw shafts 512 forwardly rotate around a center axis J. According to the forward rotation of the screw shafts 512, all the sliders 513 move along the center axis J to the inner circumference side, that is, in a direction approaching the rotation axis O. Consequently, all the first piezoelectric vibrators 400A collectively move in the direction approaching the rotation axis O. Conversely, as indicated by dash lines in FIG. 1, when the gear 520 reversely rotates around the rotation axis O by the driving forces of the second piezoelectric vibrators 400B, all the screw shafts 512 reversely rotate around the center axis J. According to the reverse rotation of the screw shafts 512, all the sliders 513 move along the center axis J to the outer circumference side, that is, in a direction separating from the rotation axis O. Consequently, all the first piezoelectric vibrators 400A collectively move in the direction separating from the rotation axis O.

In this way, with the moving mechanism 500, it is possible to collectively move all the first piezoelectric vibrators 400A simply by rotating the gear 520. If the rotation of the screw shafts 512 is stopped, it is possible to cause the first piezoelectric vibrators 400A to stay in places where the first piezoelectric vibrators 400A are present. Therefore, the configuration of the moving mechanism 500 is simplified. The distances of all the first piezoelectric vibrators 400A from the rotation axis O are equalized. Equal driving forces are transmitted from the first piezoelectric vibrators 400A to the rotor 300. Therefore, it is possible to smoothly rotate the rotor 300 with excellent energy efficiency.

The moving mechanism 500 is explained above. However, the moving mechanism 500 is not particularly limited if the moving mechanism 500 can move the first piezoelectric vibrators 400A in the directions approaching and separating from the rotation axis O. For example, as shown in FIG. 2, in this embodiment, the center axis J of the screw shafts 512 extends along the radial direction of the rotor 300. However, not only this, but the center axis J may tilt with respect to the radial direction of the rotor 300. In this embodiment, the plurality of ball screws 510 are disposed. However, not only this, but one ball screw 510 may be provided. That is, one first piezoelectric vibrator 400A may be provided. In this embodiment, the plurality of ball screws 510 are disposed at equal intervals around the rotation axis O. However, the plurality of ball screws 510 may be disposed at unequal intervals.

Subsequently, the first and second piezoelectric vibrators 400A and 400B are explained. The first and second piezoelectric vibrators 400A and 400B have the same configuration. As shown in FIG. 3, each of the first and second piezoelectric vibrators 400A and 400B includes a vibrating section 411, a supporting section 412 that supports the vibrating section 411, a coupling section 413 that couples the vibrating section 411 and the supporting section 412, and a convex transmitting section 414 disposed at the distal end portion of the vibrating section 411.

The vibrating section 411 is formed in a plate shape having the Z-axis direction as a thickness direction and expanding on an X-Y plane including the X axis and the Y axis. The vibrating section 411 includes piezoelectric elements 420A to 420F for driving and a piezoelectric element 420G for detection that detects vibration of the vibrating section 411. The piezoelectric elements 420C and 420D are disposed side by side in the Y-axis direction in the center of the vibrating section 411. The piezoelectric elements 420A and 420B are disposed side by side in the Y-axis direction on an X-axis direction plus side of the piezoelectric elements 420C and 420D. The piezoelectric elements 420E and 420F are disposed side by side in the Y-axis direction on an X-axis direction minus side. Each of the piezoelectric elements 420A to 420F extends and contracts in the Y-axis direction with energization. However, the number and the disposition of piezoelectric elements for driving are not particularly limited if desired vibration is excited in the vibrating section 411.

The piezoelectric element 420G for detection is disposed between the piezoelectric elements 420C and 420D. The piezoelectric element 420G receives external force corresponding to the vibration of the vibrating section 411 and outputs a detection signal corresponding to the received external force. Therefore, a driving state of the piezoelectric motor 100 can be detected based on the detection signal output from the piezoelectric element 420G. The number and the disposition of piezoelectric elements for detection are not particularly limited if the vibration of the vibrating section 411 can be detected. The piezoelectric elements for detection may be omitted.

The piezoelectric elements 420A to 420F each have, for example, a configuration in which a piezoelectric body is sandwiched by a pair of electrodes. A constituent material of the piezoelectric body is not particularly limited. Piezoelectric ceramics such as lead zirconate titanate (PZT), barium titanate, lead titanate, potassium niobate, lithium niobate, lithium tantalate, sodium tungstate, zinc oxide, barium strontium titanate (BST), strontium bismuth tantalate (SBT), lead metaniobate, and lead scandium niobate can be used. As the piezoelectric body, besides the piezoelectric ceramics described above, polyvinylidene fluoride, crystal, and the like may be used. A method of forming the piezoelectric body is not particularly limited. The piezoelectric body may be formed from a bulk material or may be formed using a sol-gel method or a sputtering method.

The transmitting section 414 is provided at the distal end portion of the vibrating section 411 and projects to a Y-axis direction minus side from the vibrating section 411. In the first piezoelectric vibrator 400A, the transmitting section 414 is in contact with the upper surface of the rotor main body 320. Therefore, the vibration of the vibrating section 411 is transmitted to the rotor 300 via the transmitting section 414. In the second piezoelectric vibrator 400B, the transmitting section 414 is in contact with the inner circumferential surface 521a of the gear 520. Therefore, the vibration of the vibrating section 411 is transmitted to the gear 520 via the transmitting section 414.

For example, when a driving signal V1 shown in FIG. 4 is applied to the piezoelectric elements 420A and 420F, a driving signal V2 shown in FIG. 4 is applied to the piezoelectric elements 420C and 420D, and a driving signal V3 shown in FIG. 4 is applied to the piezoelectric elements 420B and 420E, as shown in FIG. 5, the vibrating section 411 performs bending vibration in the X-axis direction while performing stretching vibration in the Y-axis direction. These vibrations are combined and the distal end of the transmitting section 414 performs an elliptical motion for drawing an elliptical track counterclockwise as indicated by an arrow A1. In the first piezoelectric vibrator 400A, the rotor 300 is sent out in the circumferential direction by such an elliptical motion of the transmitting section 414. The rotor 300 forwardly rotates around the rotation axis O. On the other hand, in the second piezoelectric vibrator 400B, the gear 520 is sent out in the circumferential direction by such an elliptical motion of the transmitting section 414. The gear 520 forwardly rotates around the rotation axis O. When waveforms of the driving signals V1 and V3 are switched, each of the rotor 300 and the gear 520 reversely rotates. The “elliptical motion” has a meaning including, besides a motion, a track of which coincides with an ellipse, for example, a motion, a track of which slightly deviates from the ellipse, such as a circular or oval motion.

In the following explanation, for convenience of explanation, stretching vibration in the Y-axis direction of the vibrating section 411 is referred to as “reciprocating vibration” as well and bending vibration in the X-axis direction is referred to as “bending vibration” as well. The reciprocating vibration is excited by the application of the driving signal V2 to the piezoelectric elements 420C and 420D. The bending vibration is excited by the application of the driving signals V1 and V3 to the piezoelectric elements 420A, 420B, 420E, and 420F. Therefore, the reciprocating vibration is controlled by the driving signal V2. The bending vibration is controlled by the driving signals V1 and V3.

As shown in FIG. 6, the first piezoelectric vibrator 400A is held by the slider 513 via an urging member 490A. The urging member 490A urges the first piezoelectric vibrator 400A toward the rotor 300 and presses the transmitting section 414 against the upper surface of the rotor main body 320. Consequently, it is possible to efficiently transmit a driving force of the first piezoelectric vibrator 400A to the rotor 300. The second piezoelectric vibrator 400B is held by the base 200 via an urging member 490B. The urging member 490B urges the second piezoelectric vibrator 400B toward the gear 520 and presses the transmitting section 414 against the inner circumferential surface 521a of the gear 520. Consequently, it is possible to efficiently transmit a driving force of the second piezoelectric vibrator 400B to the gear 520.

Each of the urging members 490A and 490B includes a holding section 491 that holds the supporting section 412, a fixed section 492 fixed to a target object, and spring groups 493 and 494 that couple the holding section 491 and the fixed section 492. The urging member 490A is fixed to the slider 513 in a state in which the spring groups 493 and 494 are bent. The urging member 490A urges the first piezoelectric vibrator 400A toward the rotor 300 using restoration forces of the spring groups 493 and 494. On the other hand, the urging member 490B is fixed to the base 200 in the state in which the spring groups 493 and 494 are bent. The urging member 490B urges the second piezoelectric vibrator 400B toward the gear 520 using the restoration forces of the spring groups 493 and 494. However, the configuration of the urging members 490A and 490B is not particularly limited. The urging members 490A and 490B may be omitted. For convenience of explanation, illustration of the urging members 490A and 4906 is omitted in the figures other than FIG. 6.

In this way, the first piezoelectric vibrator 400A is pressed against the rotor 300 by the urging member 490A. Therefore, if the driving of the first piezoelectric vibrator 400A is stopped, the first piezoelectric vibrator 400A acts as a brake that hinders the rotation of the rotor 300. A rotation angle of the rotor 300 can be maintained. Similarly, the second piezoelectric vibrator 400B is pressed against the gear 520 by the urging member 4906. Therefore, if the driving of the second piezoelectric vibrator 400B is stopped, the second piezoelectric vibrator 400B acts as a brake that hinders the rotation of the gear 520. A rotation angle of the gear 520 can be maintained. In this way, with the piezoelectric motor 100, since the first and second piezoelectric vibrators 400A and 400B function as both of driving sources and brakes, it is unnecessary to separately provide brakes besides the driving sources. Therefore, it is possible to achieve a reduction in the size of the piezoelectric motor 100.

The control device 800 is configured from, for example, a computer and includes a processor that processes information, a memory communicably coupled to the processor, and an external interface. A program executable by the processor is stored in the memory. The processor reads and executes the program stored in the memory. Such a control device 800 receives a command from a not-shown host computer and drives the first and second piezoelectric vibrators 400A and 400B based on the command.

Note that, in this embodiment, all the first piezoelectric vibrators 400A are collectively controlled and all the second piezoelectric vibrators 400B are collectively controlled. Consequently, a circuit configuration is simplified. However, not only this, but, for example, the first and second piezoelectric vibrators 400A and 400B may be divided into several groups and controlled for each of the groups. All the first and second piezoelectric vibrators 400A and 400B may be independently controlled.

The configuration of the piezoelectric motor 100 is explained above. In such a piezoelectric motor 100, as explained above, the first piezoelectric vibrator 400A can be moved along the radial direction of the rotor 300 by the driving of the second piezoelectric vibrator 400B. By moving the first piezoelectric vibrator 400A along the radial direction of the rotor 300 in this way, it is possible to change a separation distance D between the rotation axis O and the first piezoelectric vibrator 400A. Consequently, compared with the piezoelectric motor of the related art in which the separation distance D is fixed, it is possible to secure a wide rotating speed region of the rotor 300.

For example, as shown in FIG. 7, if the first piezoelectric vibrator 400A is moved to the outermost circumference side and the separation distance D is set to a maximum value Dmax, it is possible to rotate the rotor 300 at low rotating speed and large torque. Conversely, if the first piezoelectric vibrator 400A is moved to the innermost circumference side and the separation distance D is set to a minimum value Dmin, it is possible to rotate the rotor 300 at small torque and high rotating speed. Therefore, with the piezoelectric motor 100, for example, as in a CVT (Continuously Variable Transmission) of an automobile, it is possible to select an optimum driving state by changing the position of the first piezoelectric vibrator 400A according to necessary rotating speed and necessary torque. Therefore, it is possible to exert excellent driving efficiency.

For example, when the rotor 300 is accelerated from a stop state, large torque is necessary compared with when the rotor 300 is rotated at constant speed. When the large torque is necessary in this way, it is possible to accelerate the rotor 300 with excellent driving efficiency by increasing the separation distance D. It is possible to accelerate the rotor 300 to a higher speed region by gradually reducing the separation distance D according to an increase in the rotating speed. When the rotor 300 is accelerated in this way, it is possible to accelerate the rotor 300 with excellent driving efficiency by moving the first piezoelectric vibrator 400A in the direction approaching the rotation axis O according to the increase in the rotating speed of the rotor 300.

When small torque for maintaining the rotating speed is enough, it is possible to maintain the rotating speed with less energy by sufficiently reducing the separation distance D.

When the rotor 300 is decelerated and stopped, large torque is necessary as at the acceleration time. Therefore, it is possible to decelerate and stop the rotor 300 with excellent driving efficiency by gradually increasing the separation distance D according to a decrease in the rotating speed. When the rotor 300 is decelerated in this way, it is possible to decelerate the rotor 300 with excellent driving efficiency by moving the first piezoelectric vibrator 400A in the direction separating from the rotation axis O according to the decrease in the rotating speed of the rotor 300.

For example, in some case, it is desired to move the position of the first piezoelectric vibrator 400A to a predetermined position prior to the driving of the piezoelectric motor 100. In this case, in a state in which the first piezoelectric vibrator 400A is caused to perform reciprocating vibration, by driving the second piezoelectric vibrator 400B, it is possible to easily move the first piezoelectric vibrator 400A without rotating the rotor 300. As explained above, in the state in which the first piezoelectric vibrator 400A is not driven, the first piezoelectric vibrator 400A is pressed against the rotor 300. Therefore, in the state in which the first piezoelectric vibrator 400A is not driven, it is difficult to move the first piezoelectric vibrator 400A. If the first piezoelectric vibrator 400A is driven by the elliptical vibration, the rotor 300 rotates and the rotation angle fluctuates.

In contrast, in the state in which the first piezoelectric vibrator 400A is caused to perform the reciprocating vibration, since a force for sending out the rotor 300 is not generated, the rotation of the rotor 300 is hindered. Further, since the first piezoelectric vibrator 400A repeats contact with and separation from the rotor 300, the rotator 300 is in a state in which the brake is substantially released. Therefore, in the state in which the first piezoelectric vibrator 400A is caused to perform the reciprocating vibration, by driving the second piezoelectric vibrator 400B, it is possible to easily move the first piezoelectric vibrator 400A without rotating the rotor 300.

The second piezoelectric vibrator 400B functions as a sensor that detects an output load applied to the output shaft 310 at a stop time, that is, when driving for moving the first piezoelectric vibrator 400A is not performed. That is, the second piezoelectric vibrator 400B also services as the sensor that detects the output load. The output load applied to the output shaft 310 is transmitted to the second piezoelectric vibrator 400B through the rotor 300, the first piezoelectric vibrator 400A, and the moving mechanism 500. Therefore, stress corresponding to the output load is applied to the second piezoelectric vibrator 4008. The piezoelectric element 420G for detection is distorted by the stress. A detection signal corresponding to the distortion is output from the second piezoelectric vibrator 400B.

Therefore, the control device 800 may calculate an output load based on the detection signal output from the second piezoelectric vibrator 400B, calculate, from the calculated output load, optimum torque necessary for rotation of the rotor 300, calculate the separation distance D at which the calculated optimum torque can be generated, and move the first piezoelectric vibrator 400A to be at the calculated separation distance D. Consequently, it is possible to rotate the rotor 300 at torque that can resist the output load. The piezoelectric motor 100 is smoothly driven. When the rotating speed of the rotor 300 cannot be maintained when the calculated optimum torque is generated, the separation distance D can also be controlled to generate larger torque in a range in which the rotating speed can be maintained.

The piezoelectric motor 100 and the control method for the piezoelectric motor 100 are explained above. Such a piezoelectric motor 100 includes, as explained above, the rotor 300 functioning as the driven body that rotates around the rotation axis O, the first piezoelectric vibrators 400A that transmit driving forces to the rotor 300, the moving mechanism 500 that moves the first piezoelectric vibrators 400A in the directions approaching and separating from the rotation axis O, and the second piezoelectric vibrators 400B that transmit driving forces to the moving mechanism 500. With such a configuration, it is possible to secure a wider speed region by changing the positions of the first piezoelectric vibrators 400A. It is possible to rotate the rotor 300 with an excellent driving characteristic by changing the positions of the first piezoelectric vibrators 400A according to necessary rotating speed and necessary torque.

As explained above, the moving mechanism 500 includes the screw shafts 512 that rotate around the axis with the driving forces of the second piezoelectric vibrators 400B and are disposed along the directions approaching and separating from the rotation axis O and the sliders 513 functioning as the holding sections that screw with the screw shafts 512 and hold the first piezoelectric vibrators 400A. Consequently, by rotating the screw shafts 512, it is possible to move the first piezoelectric vibrators 400A in the directions approaching and separating from the rotation axis O. If the rotation of the screw shafts 512 is stopped, it is possible to cause the first piezoelectric vibrators 400A to stay in places where the first piezoelectric vibrators 400A are present. Therefore, the configuration of the moving mechanism 500 is simplified.

As explained above, the moving mechanism 500 includes the plurality of screw shafts 512 and the gear 520 that collectively rotates the plurality of screw shafts 512. Consequently, it is possible to collectively move the plurality of first piezoelectric vibrators 400A in the directions approaching and separating from the rotation axis O. Therefore, the configuration of the moving mechanism 500 is simplified. The distances of all the first piezoelectric vibrators 400A from the rotation axis O are equalized. Equal driving forces are transmitted from the first piezoelectric vibrators 400A to the rotor 300. Therefore, it is possible to smoothly rotate the rotor 300 with excellent energy efficiency.

As explained above, the second piezoelectric vibrator 400B also serves as the sensor that detects an output load. Consequently, it is possible to control the position of the first piezoelectric vibrator 400A such that torque corresponding to the output load is generated. Therefore, a driving characteristic of the piezoelectric motor 100 is improved. It is possible to achieve a reduction in the size of the piezoelectric motor 100 compared with when a sensor is provided separately from the second piezoelectric vibrator 400B.

As explained above, the control method for the piezoelectric motor 100 including the rotator 300 that rotates around the rotation axis O, the first piezoelectric vibrators 400A that transmit driving forces to the rotor 300, the moving mechanism 500 that moves the first piezoelectric vibrators 400A in the directions approaching and separating from the rotation axis O, and the second piezoelectric vibrators 400B that transmit driving forces to the moving mechanism 500 includes, when accelerating the rotor 300, moving the first piezoelectric vibrators 400A in the direction approaching the rotation axis O according to an increase in the rotating speed of the rotor 300. Consequently, it is possible to smoothly accelerate the rotor 300.

As explained above, the control method for the piezoelectric motor 100 includes, when decelerating the rotor 300, moving the first piezoelectric vibrators 400A in the direction separating from the rotation axis O according to a decrease in the rotating speed of the rotor 300. Consequently, it is possible to smoothly decelerate the rotor 300.

As explained above, when the first piezoelectric vibrators 400A are moved in the directions approaching and separating from the rotation axis O in the state in which the rotor 300 is stopped, the first piezoelectric vibrators 400A are caused to perform the reciprocating movement in the directions approaching and separating from the rotor 300. Consequently, it is possible to smoothly move the first piezoelectric vibrators 400A in the directions approaching and separating from the rotation axis O.

### Second Embodiment

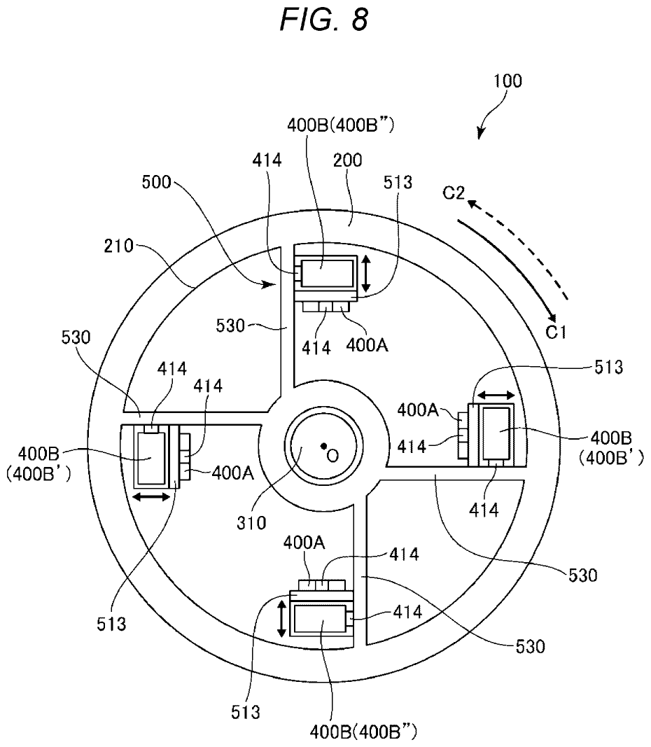

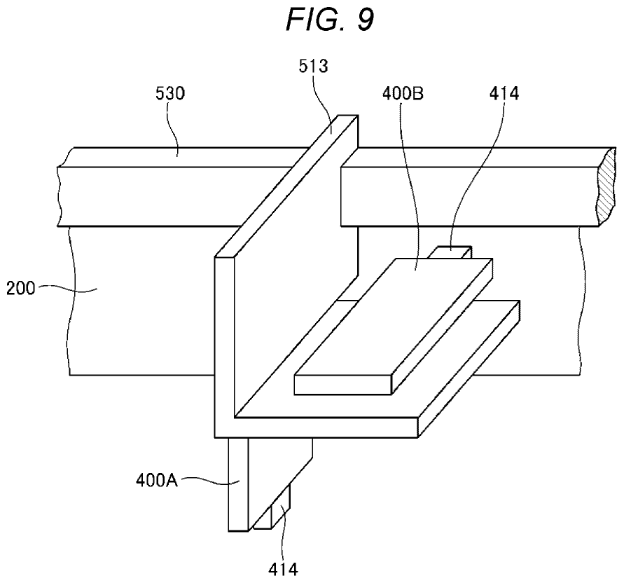

FIG. 8 is a plan view showing a moving mechanism of a piezoelectric motor according to a second embodiment of the present disclosure. FIG. 9 is a perspective view showing a slider included in the moving mechanism.

The piezoelectric motor in this embodiment is the same as the piezoelectric motor in the first embodiment except that the configuration of the moving mechanism 500 is different. In the following explanation, concerning this embodiment, differences from the first embodiment are mainly explained and explanation of similarities to the first embodiment is omitted. In FIG. 8, the same components as the components in the first embodiment are denoted by the same reference numerals and signs.

As shown in FIGS. 8 and 9, the moving mechanism 500 in this embodiment includes a plurality of sliders 513 and a plurality of guides 530 that guide the sliders 513 to be movable in the radial direction of the rotor 300. The first piezoelectric vibrators 400A and the second piezoelectric vibrators 400B are held by the sliders 513. The second piezoelectric vibrators 4008 face the circumferential direction orthogonal to the radial direction of the rotor 300 and are pressed against the base 200 by the urging member 4908 not shown in the figures. Therefore, it is possible to move the sliders 513 in the radial direction of the rotor 300 along the guides 530 by driving the second piezoelectric vibrators 400B. With such a configuration, for example, compared with the first embodiment, the screw shafts 512 and the gear 520 are unnecessary. Therefore, the moving mechanism 500 simple in a configuration and small in size can be obtained.

In this embodiment, as shown in FIG. 8, the plurality of second piezoelectric vibrators 400B include second piezoelectric vibrators 400B′ facing a forward rotation direction C1 of the rotor 300 and second piezoelectric vibrators 400B″ facing a reverse rotation direction C2 of the rotor 300. By adopting such a configuration, when the rotor 300 forwardly rotates, an output load applied at the rotation time is applied to the second piezoelectric vibrators 400B″ facing the reverse rotation direction of the rotor 300. Detection signals corresponding to the output load are output from the second piezoelectric vibrators 400B″. Conversely, when the rotor 300 reversely rotates, an output load applied at the rotation time is applied to the second piezoelectric vibrators 400B′ facing the forward rotation direction of the rotor 300. Detection signals corresponding to the output load are output from the second piezoelectric vibrators 400B′. Therefore, irrespective of in which of the forward and reverse rotation directions the rotor 300 rotates, it is possible to detect an output load applied at that time. However, the second piezoelectric vibrators 400B are not particularly limited. For example, all the second piezoelectric vibrators 400B may face one of the forward rotation direction and the reverse rotation direction of the rotor 300.

As explained above, the moving mechanism 500 in this embodiment includes the sliders 513 functioning as the holding sections that hold the first piezoelectric vibrators 400A and the second piezoelectric vibrators 400B and move in the directions approaching and separating from the rotation axis O with the driving forces of the second piezoelectric vibrators 400B. Consequently, the configuration of the moving mechanism 500 is simplified.

According to such a second embodiment, it is possible to exert the same effects as the effects of the first embodiment.

### Third Embodiment

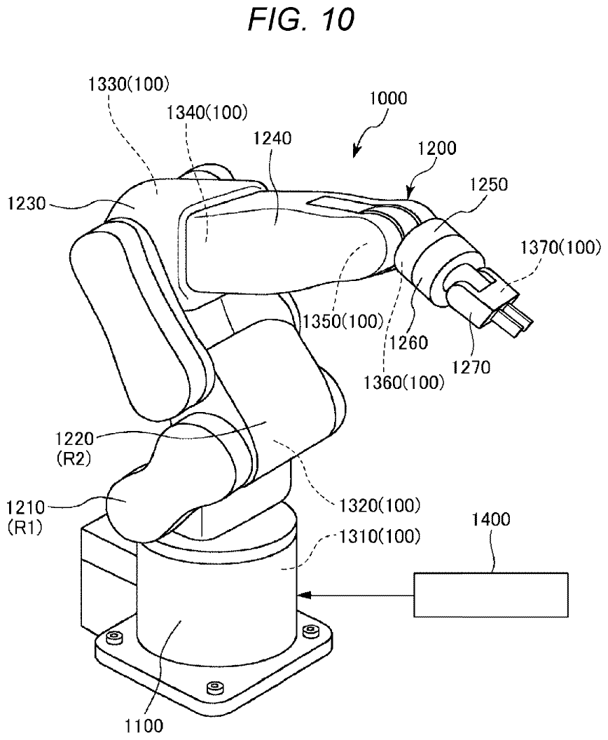

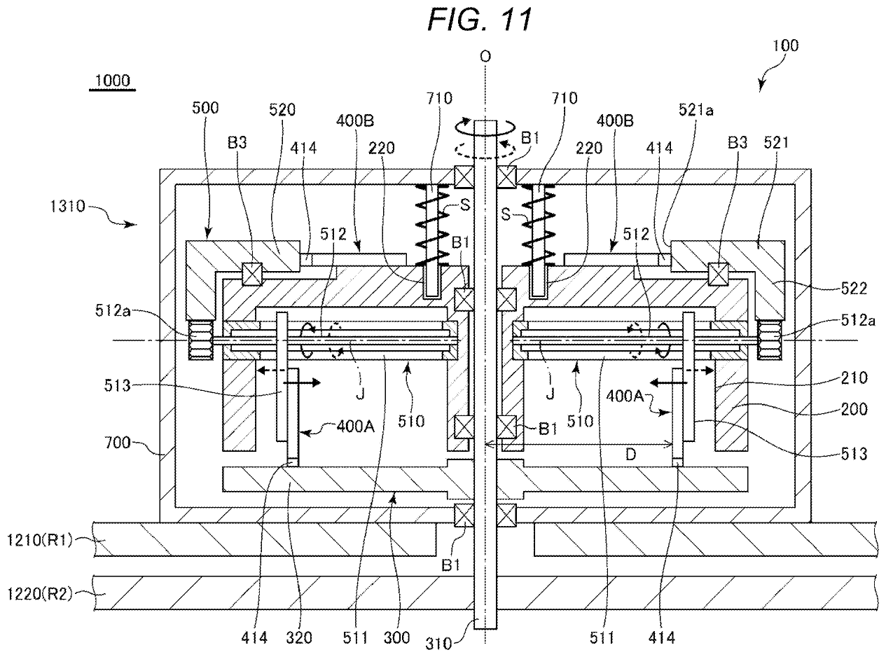

FIG. 10 is a perspective view showing a robot according to a third embodiment of the present disclosure. FIG. 11 is a sectional view showing a joint portion of a first arm and a second arm.

A robot 1000 shown in FIG. 10 can perform work such as supply, removal, conveyance, and assembly of a precision instrument and components configuring the precision instrument. Such a robot 1000 is a six-axis articulated robot and includes a base 1100 fixed to a floor or a ceiling and a manipulator 1200 supported by the base 1100.

The manipulator 1200 is a robotic arm including a plurality of mutually coupled arms to thereby operate at a plurality of degrees of freedom. The manipulator 1200 includes a first arm 1210 turnably coupled to the base 1100, a second arm 1220 turnably coupled to the first arm 1210, a third arm 1230 turnably coupled to the second arm 1220, a fourth arm 1240 turnably coupled to the third arm 1230, a fifth arm 1250 turnably coupled to the fourth arm 1240, a sixth arm 1260 turnably coupled to the fifth arm 1250, and an end effector 1270 attached to the sixth arm 1260.

Any one selected out of the first to sixth arms 1210 to 1260 and the end effector 1270 can be set as a first member and any one selected out of the first to sixth arms 1210 to 1260 and the end effector 1270 excluding the first member can be set as a second member. For example, when a relatively movable plurality of members, for example, a pair of claws for gripping a workpiece is present in the end effector 1270, one claw can be set as the first member and the other claw can be set as the second member. In the illustrated configuration, the first arm 1210 is set as a first member R1 and the second arm 1220 is set as a second member R2.

The robot 1000 includes a first arm turning mechanism 1310 that is disposed in a joint of the base 1100 and the first arm 1210 and turns the first arm 1210 with respect to the base 1100, a second arm turning mechanism 1320 that is disposed in a joint of the first arm 1210 and the second arm 1220 and turns the second arm 1220 with respect to the first arm 1210, a third arm turning mechanism 1330 that is disposed in a joint of the second arm 1220 and the third arm 1230 and turns the third arm 1230 with respect to the second arm 1220, a fourth arm turning mechanism 1340 that is disposed in a joint of the third arm 1230 and the fourth arm 1240 and turns the fourth arm 1240 with respect to the third arm 1230, a fifth arm turning mechanism 1350 that is disposed in a joint of the fourth arm 1240 and the fifth arm 1250 and turns the fifth arm 1250 with respect to the fourth arm 1240, a sixth arm turning mechanism 1360 that is disposed in a joint of the fifth arm 1250 and the sixth arm 1260 and turns the sixth arm 1260 with respect to the fifth arm 1250, and an end effector driving mechanism 1370 that drives the end effector 1270. The robot 1000 includes a robot control section 1400 that controls driving of the first to sixth arm turning mechanisms 1310 to 1360 and the end effector driving mechanism 1370.

In a part or all of the first to sixth arm turning mechanisms 1310 to 1360 and the end effector driving mechanism 1370, the piezoelectric motors 100 are mounted as power sources thereof. The first to sixth arms 1210 to 1260 and the end effector 1270 set as targets are driven by driving of the piezoelectric motors 100. Therefore, the robot 1000 can enjoy the effects of the piezoelectric motor 100 explained above and can realize excellent driving efficiency.

As explained above, in the piezoelectric motor 100, the first piezoelectric vibrators 400A move and the separation distance D is variable. Therefore, the piezoelectric motor 100 functions as a speed reducer as well by changing the separation distance D. That is, the piezoelectric motor 100 also serves as the speed reducer. Therefore, as shown in FIG. 11, in the first arm turning mechanism 1310, the case 700 is fixed to the first arm 1210 and the output shaft 310 is fixed to the second arm 1220. A speed reducer that decelerates rotation of the rotor 300 is not provided between the rotor 300 and the second arm 1220. Therefore, it is possible to achieve a reduction in the size of the first arm turning mechanism 1310. The same applies to the second to sixth arm turning mechanisms 1320 to 1360 and the end effector driving mechanism 1370.

As explained above, the first piezoelectric vibrator 400A also functions as a brake that stops driving of the first piezoelectric vibrator 400A to thereby hinder the rotation of the rotor 300 and maintain relative positions of the coupled arms. Therefore, as shown in FIG. 11, in the first arm turning mechanism 1310, a brake that hinders the rotation of the rotor 300 is not provided separately from the piezoelectric motor 100. Therefore, it is possible to achieve a reduction in the size of the first arm turning mechanism 1310. The same applies to the second to sixth arm turning mechanisms 1320 to 1360 and the end effector driving mechanism 1370.

As explained above, the robot 1000 includes the first arm 1210 functioning as the first member and the second arm 1220 functioning as the second member coupled to each other and the piezoelectric motor 100 that displaces the second arm 1220 with respect to the first arm 1210. Therefore, the robot 1000 can enjoy the effects of the piezoelectric motor 100 and can realize excellent driving efficiency.

According to such a third embodiment, it is possible to exert the same effects as the effects in the first embodiment.

The piezoelectric motor, the control method for the piezoelectric motor, and the robot according to the present disclosure are explained above with reference to the embodiments shown in the drawings. However, the present disclosure is not limited to the embodiments. The components of the sections can be replaced with any components having the same functions. Any other components may be added to the present disclosure. The embodiments may be combined as appropriate. In the embodiments, the configuration in which the control method for the piezoelectric motor is applied to the robot is explained. However, the control method for the piezoelectric motor can also be applied to, other than the robot, various electronic devices that need a driving force, for example, a printer and a projector.

What is claimed is:

1. A piezoelectric motor comprising:
a driven body configured to rotate around a rotation axis;
a first piezoelectric vibrator configured to transmit a driving force to the driven body;
a moving mechanism configured to move the first piezoelectric vibrator in directions approaching and separating from the rotation axis; and
a second piezoelectric vibrator configured to transmit a driving force to the moving mechanism.

2. The piezoelectric motor according to claim 1, wherein the moving mechanism includes:
a screw shaft configured to rotate around an axis with the driving force of the second piezoelectric vibrator and disposed along the directions; and
a holding section configured to screw with the screw shaft and hold the first piezoelectric vibrator.

3. The piezoelectric motor according to claim 2, wherein the moving mechanism includes:
a plurality of the screw shafts; and
a gear configured to collectively rotate the plurality of screw shafts.

4. The piezoelectric motor according to claim 1, wherein the moving mechanism includes a holding section configured to hold the first piezoelectric vibrator and the second piezoelectric vibrator and move in the directions with the driving force of the second piezoelectric vibrator.

5. The piezoelectric motor according to claim 1, wherein the second piezoelectric vibrator also serves as a sensor that detects an output load.

6. A control method for a piezoelectric motor comprising:
a driven body configured to rotate around a rotation axis;
a first piezoelectric vibrator configured to transmit a driving force to the driven body;
a moving mechanism configured to move the first piezoelectric vibrator in directions approaching and separating from the rotation axis; and
a second piezoelectric vibrator configured to transmit a driving force to the moving mechanism,
the control method comprising, when accelerating the driven body, according to an increase in rotating speed of the driven body, moving the first piezoelectric vibrator in the direction approaching the rotation axis.

7. The control method for the piezoelectric motor according to claim 6, further comprising, when decelerating the driven body, according to a decrease in the rotating speed of the driven body, moving the first piezoelectric vibrator in the direction separating from the rotation axis.

8. The control method for the piezoelectric motor according to claim 6, further comprising, when moving the first piezoelectric vibrator in the directions in a state in which the driven body is stopped, causing the first piezoelectric vibrator to perform reciprocating vibration in directions approaching and separating from the driven body.

9. A robot comprising:
a first member and a second member coupled to each other; and
the piezoelectric motor according to claim 1 configured to displace the second member with respect to the first member.
